(19) United States
(12) Patent Application Publication
(10) Pub. No.: US 2008/0178767 A1
(43) Pub. Date: Jul. 31, 2008

(54) Dry-Spray Products For Protecting Centrifugal Casting Molds of Cast Iron Pipes in Association With a Wet-Spray Product

(75) Inventors: Thomas Margaria, Chambery (FR); Roland Siclari, Pompey (FR)

Correspondence Address: CANTOR COLBURN, LLP, 20 Church Street, 22nd Floor, Hartford, CT, 06103, US

(73) Assignee: PECHINEY ELECTROMETALLURGIE, CHAMBERY (FR)

(21) Appl. No.: 11/911,877

(22) PCT Filed: Mar. 29, 2006
(86) PCT No.: PCT/FR2006/000676

§ 371 Date: Oct. 18, 2007

(30) Foreign Application Priority Data
Apr. 20, 2005 (FR) 0503949

(51) Int. Cl. B28B 7/36

(52) U.S. Cl. 106/38.27

(57) ABSTRACT

The invention relates to a powder product for protecting centrifugal casting molds of cast iron pipes, dry-projected onto a first wet-spray layer, comprising constituents common to dry-spray products with exception of CaSi alloys, as well as a wet-spray additive serving to ensure the adhesion to the pipe, during its removal from the mold, initially applied to the permanent mold. Said additive can be an alkali carbonate or alkali silicate, for example, sodium silicate in which the ratio of the wt. % of SiO₂ to that of Na₂O varies from 1 to 3, or anhydrous sodium metasilicate as well as a mixture consisting of one or more thereof in any proportions.

### TECHNICAL FIELD OF THE INVENTION

The invention relates to a product in the form of powder, of the dry-spray type, intended for protecting the moulds used for the centrifugal casting of cast iron pipes, combined with a sublayer product of the wet-spray type; the casting moulds used are commonly referred to by the name “shells”.

### BRIEF DESCRIPTION OF RELATED ART

Unless otherwise indicated, all the values relating to chemical compositions are expressed in percentages by weight.

The coatings used for protecting centrifugal casting shells for cast iron pipes may consist of inoculants and refractories in powder form, and also mixtures of silica and bentonite, these being put into place by spraying an aqueous suspension. Such coatings are described for example in patent U.S. Pat. No. 4,058,153 (Pont-A-Mousson) and are known as wet-spray coatings.

It is also usual to employ powders sprayed dry onto the shell before the iron is cast, these powders then being referred to as dry-spray powders.

In the case of pipes with a diameter typically greater than 400 mm, it is common practice to combine the two types of product, that is to say:
a first layer of the wet-spray type, consisting of a mixture of silica and bentonite, which dries rapidly after being sprayed onto the hot shell; and
a second layer of the dry-spray type, sprayed onto the first layer before the iron is cast.

Whatever the technique employed for depositing them, these products are used for several purposes, in particular:
to obtain a mould release effect, that is to say making it easier to extract the pipe from the mould after solidification;
to obtain a thermal barrier effect, limiting the temperature rise of the shell thus contributing to an increase in its lifetime;
to obtain an anti-pinhole effect, that is to say limiting the risk of pinholes appearing on the surface of the pipes; and
to obtain an ultimate inoculating effect on the cast iron, so as to control the metallurgical structure of the pipe.

It is well known that insufficient inoculation in the iron results in the formation of carbides, considerable shrinkage upon cooling and rapid demoulding, a gauge of high productivity. However, the castings thus obtained require a subsequent heat treatment, which may prove to be expensive.

It may, depending on the case, be preferable to inoculate further, even if this entails a reduction in the production rate, in order to avoid the final heat treatment, or on the contrary to inoculate less, in order to raise the productivity, and to subject the casting to heat treatment downstream.

The inoculability of the product may therefore be positioned within quite broad limits; in contrast, the other required effects are subject to more constant requirements.

In the specific case of dry-spray products deposited on a wet-spray first layer, these must also allow the wet-spray layer to remain bonded to the pipe while it is being demoulded, so as to prevent its accumulation and the formation of dross in the shell with the risk of this being entrained into the iron during casting, thus forming inclusion defects in the pipe, or creating surface defects on said pipe.

Dry-spray products therefore generally consist of a blend of several components, including:
an inoculant of relatively high effectiveness, which may typically constitute 30 to 100% of the product; for example, ferro-silicon alloys may be used for this purpose, these containing 0.1 to 4% aluminium, 0.1 to 4% calcium and, optionally, other elements capable of introducing a supplementary or complementary metallurgical effect in the cast iron;
powders of elements or alloys giving specifically an anti-pinhole effect; these may typically be the elements or alloys of the reducing elements of Column 2 of the Periodic Table of Elements, for example industrial silicon-calcium alloys with a high calcium content, especially the alloy known as “CaSi” containing about 30% Ca; and
an inert mineral filler, for example silica, which may constitute up to 70% of the product.

In the specific case of dry-spray products deposited on a wet-spray first layer, such blends do not allow one of the desired objectives to be achieved, namely that of allowing the wet-spray product to remain bonded to the pipe while it is being demoulded.

For this purpose, it is common practice to use, as dry-spray product, a powder generally consisting of the “CaSi” alloy as mentioned above.

However, although this type of powder does indeed ensure that the wet-spray layer remains bonded to the pipe, it is not really satisfactory as regards the other aforementioned effects, including in particular the inoculating effect and more generally the effects relating to control of the metallurgical structure of the cast iron pipe.

### BRIEF SUMMARY OF THE INVENTION

The subject of the invention is a powder product for the protection of moulds or shells, used for the centrifugal casting of cast iron pipes, in a process comprising the following steps:
creation of a first layer, of the type known as a wet-spray layer, on the internal surface of the shell, by spraying an aqueous suspension of a mixture of silica and bentonite onto said internal surface of the hot shell;
dry-spraying, onto said first layer, of said powder product comprising an inoculating metal alloy or a blend of inoculating metal alloys, optionally powders of reducing elements or alloys having an anti-pinhole effect and optionally an inert mineral filler;
centrifugal casting of the cast iron pipe; and
demoulding of the cast iron pipe,
   said product being characterized in that it further includes at least one additive designed to ensure that the wet-spray product initially deposited on the shell remains bonded to the cast iron pipe while it is being demoulded.

According to one advantageous embodiment, the additive is an alkali metal carbonate; according to another embodiment, it is an alkali metal silicate.

The additive may also be a blend in any proportion of one or more alkali metal carbonates and/or one or more alkali metal silicates.

Preferably, the alkali metal silicate is sodium silicate in which the ratio of the mass content of the SiO₂ component to that of the Na₂O component varies from 1 to 3.

According to another preferred embodiment, the additive is anhydrous sodium metasilicate.

Finally, according to one advantageous embodiment, the mass fraction of additive in said product is between 3 and 25%.

### DETAILED DESCRIPTION OF THE INVENTION

The powder products of the prior art, used as dry-spray products for protecting the centrifugal casting moulds for cast iron pipes and sprayed dry onto a wet-spray first layer obtained beforehand by spraying an aqueous suspension of a mixture of silica and bentonite onto the hot shell, have a number of drawbacks. Specifically, if they consist, like the dry-spray products that are sprayed dry directly onto the shell, of several components, in particular including:
an inoculant typically consisting of 30 to 100% of the product and typically based on ferro-silicon alloys containing 0.1 to 4% of aluminium and of calcium, optionally combined with other elements capable of introducing a supplementary or complementary metallurgical effect in the cast iron;
powders of reducing elements or alloys of reducing elements specifically giving an anti-pinhole effect for example silicon alloys with a high calcium content, such as in particular the “CaSi” alloy containing about 30% Ca; and
an inert mineral filler, for example silica, which may constitute up to 70% of the product, they do not allow the wet-spray product to remain bonded to the pipe while it is being demoulded, thus contributing to an increased risk of dross being deposited on the shells and of inclusions being formed in the cast iron, it also being possible for this dross to result, in addition to inclusions, in surface defects on the pipes.

The inert mineral filler when present in an excessively large amount has the same risk.

One solution consists in increasing the “CaSi” alloy content of the dry-spray product, generally even up to 100%.

However, although the desired effect of keeping the wet-spray product bonded to the pipe while it is being demoulded is substantially improved, the other desirable effects are degraded thereby. This is because, although the “CaSi” alloy is itself slightly inoculating, it does not by itself control the metallographic structure of the cast iron constituting the pipe as effectively as the blends described above. Increasing its amount, in order to increase its effect, results in the same drawback as mentioned above, namely the formation of dross in the shells and more particularly in those regions of its impression that correspond to the bell ends of the pipes. This phenomenon results in inclusion defects in the pipe or surface defects thereon, generally resulting in the pipe being scrapped.

To alleviate these drawbacks, the Applicant has therefore sought to obtain a dry-spray powder product having a composite effect, that is to say one giving both the effect of keeping the wet-spray product bonded to the pipe while it is being demoulded and the other effects, namely the anti-pinhole effect, the inoculation effect and the effect of controlling the metallographic structure of the iron.

This result can be obtained by a dry-spray product consisting:
on the one hand, in respect of 75 to 97%, of a powder of the usual dry-spray type containing a blend of several components, including:
   one or more inoculants in the usual compositions, proportions and particle sizes for dry-spray products, as mentioned above,
   optionally, one or more powders of elements or alloys providing reducing elements conferring, in particular, an anti-pinhole effect, such as especially Mg, Zn, Al, Ca, etc. and
   optionally, an inert mineral filler, for example silica, but containing little or no alloy of the “CaSi” type; and
on the other hand, 3 to 25% of an additive intended specifically to ensure that the wet-spray product remains bonded to the pipe while it is being demoulded.

This additive may advantageously be an alkali metal carbonate or an alkali metal silicate, especially sodium silicate in which the ratio of the mass content of SiO₂ component to that of the Na₂O component varies from 1 to 3, or else a blend in any proportion of one or more of these additives, namely one or more alkali metal carbonates and/or one or more alkali metal silicates, or, finally, anhydrous sodium metasilicate, in all cases with a particle size of less than 350 μm. The particle size of the powder product according to the invention is less than 580 μm and preferably less than 250 μm.

### EXAMPLES

The effectiveness of wet-spray product bonding may be characterized by the percentage area of the external surface of the pipe where the wet-spray product does not remain bonded. In all the examples below, a wet-spray product was firstly deposited on the hot shell, this product containing, after drying, 95% silica (in diatomite form), 1% CaO and 3% alumina, provided by bentonite. The dry-spray product was then deposited on the wet-spray product, after it had dried merely due to the heat of the shell, using conventional techniques for depositing this type of product.

### Example 1

As a control test, a dry-spray product consisting of 100% of a “CaSi” alloy containing 61.1% Si, 30.4% Ca and 1.21% Al was used, the particle size of the product being characterized by a 63 μm undersize of 25% and a 200 μm undersize of 98%.

This product gave satisfactory results: the pipes were practically free of pinholes; the few pinholes present were shallow and allowed the specifications to be met; the carbide content was 8% and a ferritic iron thickness of 35 μm was noted on the external surface of the pipe. When demoulding the pipe, it was observed that only over 2% of its surface did the wet-spray product not remain bonded. The dross was concentrated in the bell, forming a band 15 mm in thickness therein.

### Example 2

A blend was prepared from the following constituents:
93% ferro-silicon containing 65, 5% Si, 1.3% Ca and 0.95% Al, with a particle size of less than 200 μm;
3% Mg metal powder with a particle size of between 200 and 400 μm; and
4% fluorspar with a particle size of less than 150 μm.

Particle size analysis showed that it had a 63 μm undersize of 28% and a 200 μm undersize of 97%.

Used under the same conditions as in Example 1, this product gave the following results: the pipes were practically free of pinholes; the few pinholes present were shallow and allowed the specifications to be met; the carbide content was 10% and a ferritic iron thickness of 30 μm was noted on the external surface of the pipe. These results are satisfactory. The thickness of the dross band in the bell was only 5 mm. However, the percentage area of the surface of the pipe without wet-spray product rose to 60%. It is clearly apparent that the dry-spray product of the conventional type (Example 2) has a metallurgical effect very similar to that of a dry-spray product consisting of a “CaSi” alloy alone; however, it is much less subject to the formation of dross, but is also substantially less effective as regards the wet-spray product remaining bonded to the pipe.

### Example 3

A blend was prepared from the following constituents:
77% ferro-silicon containing 65, 5% Si, 1.3% Ca and 0.95% Al, with a particle size of less than 200 μm;
3% Mg metal powder with a particle size of between 200 and 300 μm; and
20% anhydrous sodium metasilicate with a particle size of less than 350 μm.

Particle size analysis showed that it had a 63 μm undersize of 24% and a 200 μm undersize of 95%.

Used under the same conditions as in Example 1, this product gave satisfactory results for all the parameters: the pipes were practically free of pinholes; the few pinholes present were shallow and allowed the specifications to be met; the carbide content was 10% and a ferritic iron thickness of 35 μm was noted on the external surface of the pipe. The thickness of the dross band in the bell was 7 mm. The percentage area of the surface of the pipe without wet-spray product was only 3%.

A metallurgical effect similar to that of a conventional dry-spray product (Example 2), but with excellent effectiveness in respect of wet-spray product bonding to the pipe, was therefore observed, together with a very low tendency to the formation of dross (much less than for a dry-spray product consisting of “CaSi” alloy alone and similar to that of a dry-spray product of conventional type on a point test, but with a substantially reduced risk during continuous use owing to the substantially improved bonding of the wet-spray product to the pipe).

1. Powder product for protection of moulds or shells, used for centrifugal casting of cast iron pipes, in a process comprising:
creation of a first layer, of a type known as a wet-spray layer, on an internal surface of the shell, by spraying an aqueous suspension of a mixture of silica and bentonite onto said internal surface of the shell;
dry-spraying, onto said first layer, of said powder product comprising an inoculating metal alloy or a blend of inoculating metal alloys, optionally powders of reducing elements or alloys having an anti-pinhole effect and optionally an inert mineral filler;
centrifugal casting of the cast iron pipe; and
demoulding of the cast iron pipe,
wherein said product includes at least one additive designed to ensure that the wet-spray product initially deposited on the shell remains bonded to the cast iron pipe while it is being demoulded.

2. Product according to claim 1, wherein the additive is an alkali metal carbonate.

3. Product according to claim 1, wherein the additive is an alkali metal silicate.

4. Product according to claim 1, wherein the additive is a blend in any proportion of one or more alkali metal carbonates and/or one or more alkali metal silicates.

5. Product according to claim 3, wherein the alkali metal silicate is sodium silicate in which a ratio of mass content of the SiO₂ component to that of the Na₂O component varies from 1 to 3.

6. Product according to claim 1, wherein the additive is anhydrous sodium metasilicate.

7. Product according to claim 1, wherein the mass fraction of additive in said product is between 3 and 25%.
